(19) United States
(12) Patent Application Publication
(10) Pub. No.: US 2022/0107983 A1
(43) Pub. Date: Apr. 7, 2022

(54) Methods and Systems of PNDF Dual and BTF based Document Frequency Weighting Schemes

(71) Applicant: Arthur Jun Zhang, (US)

(72) Inventor: Arthur Jun ZHANG, CAMBRIDGE, MA (US)

(73) Assignee: Arthur Jun ZHANG, CAMBRIDGE, MA (US)

(21) Appl. No.: 17/490,117

(22) Filed: Sep. 30, 2021

Related U.S. Application Data
(60) Provisional application No. 63/088,430, filed on Oct. 6, 2020.

(51) Int. Cl. G06F 16/93

(52) U.S. Cl. CPC G06F 16/93

(57) ABSTRACT

The present invention first proposes a novel expression for pairwise positive document weighting scheme and defines its symmetric dual, negative document frequency weight scheme. Their relation equations are derived and their global normalized forms are also provided. Their combination positive negative document scheme is also defined, which can quantify the features' capability of measuring the commonness of documents as well as the features' capability of distinguishing documents. The invention further proposes another form for positive document frequency via applying the strict proper score algorithm and its dual form for negative document frequency is also derived. The invention also defines the binary term frequency and its associated various document representation methods when combined with different weight schemes. The extension from common discrete token features to slightly complex features such as sentences are also presented for the above schemes and term frequencies. The invention also illustrates the application details for the classical Euclidean document distance computation and the optimal transportation based document distance computation.

### FIELD OF THE INVENTION

This non-provisional invention application refers to the earlier provisional patent application #63/088,430 as a continuation.

This invention considers the document frequency weighting scheme methods in classical information retrieval systems and their applications in machine learning modeling.

It relates to the prior art of Inverse Document Frequency (IDF) and associated Term Frequency Inverse Document Frequency (TF-IDF) which has been widely used for several decades.

The invention proposes some novel document weighting methods in information retrieval, which are universally applicable to all modern machine learning method frameworks for common tasks such as classification, prediction, webpage ranking and recommendation tasks etc.

Particularly we illustrate the application to two scenarios, namely the classical Euclidean distance computation and the popular Optimal Transportation (OT) based document distance computation in natural language processing.

### BACKGROUND OF THE INVENTION

This invention cites the earlier submitted Provisional Patent Application #63/198,209 and can be regarded as some further innovative development along the series.

In information retrieval systems and machine learning, it is a general belief that the given data collection contains different amount of information for features. Some features are more informative while some features are less informative. In other words, some features have relatively more import while some features are relatively less important for the considered tasks. In the past several decades researchers have developed various feature weighting methods which assign each feature a weight quantifying its importance.

One important observation made by Karen Sparck Jones in 1972 is that if a word w appears in more documents in a corpus collection, then the word is common and it becomes less effective at distinguishing the documents. Inversely, if a word appears in very few documents, then the word is rare and it becomes very effective at distinguishing documents than frequent words. Let's use n denote the total number of documents in the corpus collection and d denote the number of documents containing the word. Then

$$\frac{n}{d}$$

is the reciprocal of the standard document frequency. To avoid the extreme situation of vanishing d=0, a simple smoothing is given by

$$\frac{c + n}{c + d} ,$$

where c is a non-negative real number. By taking the default c=1, this leads to the classical state-of-art Inverse Document Frequency formula:

$$IDF ( w ) = log ( \frac{1 + n}{1 + d} ) .$$

For the i-th document Dᵢ and the k-th word token wₖ, one can compute the term frequency(TF), denoted as fᵢₖ. It is the counts of the word wₖ in the document divided by the total number of tokens of the document. Then the famous Term Frequency-Inverse Document Frequency (TF-IDF) is just defined as the multiplication of fᵢₖ with IDF, denoted as D_{i,k}=fᵢₖDF (wₖ)

The above IDF approach comes from the point view of measuring a feature's capability of distinguishing documents. On the contrary, a simple but inspiring fact is that more sharing words appearing in two documents indicates that the two documents are more similar. From the point view of quantifying the features' capability of measuring similarity between documents, Arthur Zhang recently proposed pairwise Positive Document Frequency and the integrated PIDF which incorporates both the features' capability of distinguishing documents as well as the capability of counting commonness of documents.

However, the classical IDF is defined across the corpus as a global quantity while the PDF is defined as a local quantity for a pair of documents. The integrated PIDF works well for pairwise document distance computation. The current invention first define the normalized version of the pairwise PDF and its dual, the Negative Document Frequency and its global form. And the invention further defines the symmetric integrated Positive and Negative Document Frequency (PNDF). The invention also gives a specific algorithm to choose the parameters in the schemes, namely the Strict Proper Score method.

This and the next several following paragraphs introduce the basics of the optimal transportation based document distance computation and the downstream document classification using such computed document distance. The optimal transportation (OT) is an applied mathematical branch which studies the optimal transportation cost of moving mass from one space to another. In the past several years it has attracted a lot of interest in the machine learning community. In 2015 Kusner and his collaborators introduced the OT technique to measure the distance between documents in natural language processing.

The framework assumes that for two given documents of texts, X and Y, each is regarded as a sequence of word tokens. Ignoring the word orders, we can represent each document as a bag of words V=[w₁, w₂, . . . , wₙ]. Here n is the size of all the vocabulary in the documents. Each document can be first represented as a vector of frequency counts, and then normalized by their total sum of the frequency counts. This finally gives X=[x₁, x₂, . . . , xₙ] and Y=[y₁, y₂, . . . , yₙ], where the two vectors has unit mass. That is, the documents can be regarded as two discrete probability distributions, where the machinery from optimal transportation comes into play.

Now one can transport the total mass from X to Y, either the whole or some portion of a point xᵢ. This framework was first formulated by Kontsevich in 1942, namely balanced transportation. The total transportation cost is naturally defined as the distance weighted summation of moving all the mass from one space to another. Now one can ask what is the optimal transportation plan.

$$OT ( X , Y ) = {min}_{p} {\sum }_{ij} {P}_{ij} D i s t ( {x}_{i} , {y}_{j} ) \qquad ( 1 )$$

where P is all the possible transportation path which satisfy the following constraints: Σⱼ₌₁ⁿ Pᵢⱼ=xᵢ and Σᵢ₌₁ⁿ Pᵢⱼ=yⱼ. The Dist(xᵢ, yⱼ) is the distance between the word vectors of xᵢ and yⱼ, which are usually pretrained using popular algorithms such as Word2vec and publicly free.

Similarly, at the sentence level, i.e, we can regard each sentence as an individual feature rather than the common words. We can count the sentence frequencies in each document and form the normalized sentence vector representation for each document. That is, X=[sx₁, sx₂, . . . , sxₘ] and Y=[sy₁, sy₂, . . . , syₘ]. Here m is the total number of different sentences in the two documents. And we can have the similar OT formulation below:

$$OT ( X , Y ) = {min}_{P} {\sum }_{i , j} {P}_{i j} D i s t ( s {x}_{i} , {sy}_{j} ) \qquad ( 2 )$$

where P is all the possible transportation path which satisfy the following constraints: Σⱼ₌₁ⁿ Pᵢⱼ=sxᵢ and Σᵢ₌₁ⁿ Pᵢⱼ=syⱼ. The sentence vectors sxᵢ and syⱼ are the weighted word vectors of all the words in the sentence, where the weight type for each word is identical to the selected feature document frequency type. The Dist(sxᵢ, syⱼ) is the vector distance between sentence vectors sxᵢ and syⱼ.

This paragraph reviews the classical Euclidean distance computation for a pair of documents. Following the notations above, X=[x₁, x₂, . . . , xₙ] and Y=[y₁, y₂, . . . , yₙ], where xᵢ and yⱼ are the word token frequencies for wᵢ and wⱼ. The classical Euclidean distance between documents X and Y, denoted as Dist_{XY}, is then given as

$$D i s {t}_{XY} = \sqrt{{\sum }_{k = 1}^{n} {( {x}_{k} - {y}_{k} )}^{2}} \qquad ( 3 )$$

### SUMMARY AND OBJECTS OF THE INVENTION

The invention first proposes a general form for the pairwise Positive Document Frequency (PDF) and its symmetric dual, pairwise Negative Document Frequency (NDF). Similar to the IDF, this NDF assigns a metric to each pair of documents which accounts for the feature's capability of distinguishing a pair of documents. The invention further gives the normalized PDF and NDF for a document across the collection corpus of documents by first summing all the possible pairs and then take the average.

Next the invention propose an integrated weighting scheme, namely Positive and Negative Document Frequency (PNDF), by combining the PDF and NDF together. Both the local pairwise form and the global form across the corpus are given. The local pairwise form works naturally for each pair of document distance while the global form applies as the weighting for each document. The proposed PNDF has dual capability of assessing similarity with PDF and distinguishing with NDF. The normalized version of PNDF is a global weight scheme and the associated TF-PNDF gives a simple linear complexity representation of documents.

Among the numerous formula expression choices for PDF and NDF, the invention also proposes a Strict Proper Score Algorithm method for selecting the suitable formula forms for them and derives the final forms for PNDF.

The invention also proposes a novel Binary Term Frequency (BTF) which only incorporates the presence status of a feature for a document. Its extensive and natural combination with IDF, PDF, NDF and PNDF are also given.

The natural extension of the above weighting schemes to sentence-like complex features are also given as the summation of all the word token or symbols in the sentence level feature or alike.

The proposed schemes PDF, NDF, PNDF, BDF and IDF as well as their various combinations can easily be applied as weighting methods to either pairwise documents or a single document based metrics for downstream information retrieval and machine learning tasks. Specifically for the optimal transportation based document distance computation and Euclidean based document distance, we illustrate the procedures of applying such various weightings to the word tokens or sentence-like features.

### BRIEF DESCRIPTION OF DRAWINGS

FIG. 1 gives a brief summary of PNDF weighting procedure for pairwise weighting and normalized version for a document representation.

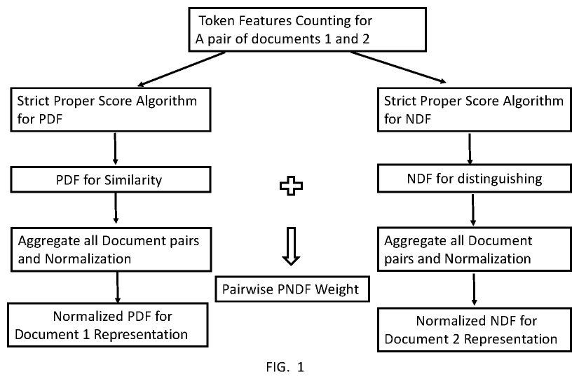

### DETAILED DESCRIPTION OF THE INVENTION

Let's first fix the notations here. For a corpus of documents, we use n denote the total number of documents. For a pair of documents, we use the indexes i and j and denote the documents as Dᵢ and Dⱼ. For token or symbol features, we use w to denote a generic work. We use m denote the total number of features. The k-th feature is denoted as wₖ, where k ∈ {1, . . . , m}. The total number of a generic feature wₖ in the corpus is the classical document frequency, denoted as dₖ ∈ {0 . . . , n}. The total counts of a token wₖ in a document Dᵢ is denoted as cᵢₖ, and the corresponding term frequency is denoted as fᵢₖ. It is the ratio of cᵢₖ with the total token counts in the document. That is

$${f}_{i k} = \frac{{c}_{i k}}{{\sum }_{t = 1}^{m} {c}_{i t}} \qquad ( 4 )$$

First recall that for a given token feature wₖ, in the prior art Provisional Patent Application #63/198,209 Arthur Zhang invented a quantity Positive Document Frequency (PDF) for each pair of documents to summarize the feature wₖ's contribution to the similarity of the two documents. For a pair of documents, if we use d to denote the total counts of the wₖ feature, then d ∈ {0,1,2}. The PDF thus has a general form below as

$$PDF ( w ) = \{ \begin{matrix}{γ}_{2} & if d = 2 \\ {γ}_{1} & if d = 1 \\ {γ}_{0} & if d = 0\end{matrix} \qquad ( 5 )$$

where and γ₀, γ₁, and γ₂ are real numbers. There are numerous ways to define these numbers in terms of d, n and the document frequency dₖ.

By taking the ratio of the γ₂ and γ₀ with respect to γ₁, we can reduce the number of parameters and further simplify the formula as following:

$$PDF ( w ) = \{ \begin{matrix}1 + {γ}_{1} & if d = 2 \\ 1 & if d = 1 \\ 1 + {γ}_{2} & if d = 0\end{matrix} \qquad ( 6 )$$

where γ₁ and γ₂ are two real numbers. γ₁ quantifies the extra effect when the feature appears in both documents while γ₂ quantifies the effect of no showing of such feature in the documents. For example,

$${γ}_{1} = log \frac{c + 2}{c + 1} and {γ}_{2} = log \frac{c}{c + 1}$$

with c=1.

For the i-th document Dᵢ by iterating through all the documents in the corpus we can sum up these pairwise PDF and then take the average. This gives the normalized PDF, denoted as nPDFᵢ(wₖ). The term has two different expressions depending upon the presence of the feature or not in the document. When the token feature wₖ appears in document Dᵢ, the normalized PDF has the following expression.

$$\begin{matrix}{nPDF}_{i} ( {w}_{k} ) = \frac{1}{n} [ {d}_{k} ( 1 + {γ}_{1} ) + n - {d}_{k} ] \\ = 1 + \frac{{d}_{k}}{n} {γ}_{1}\end{matrix} \qquad ( 7 )$$

When the token feature wₖ does not appear in document Dᵢ, the normalized PDF has the following expression.

$$\begin{matrix}{nPDF}_{i} ( {w}_{k} ) = \frac{1}{n} [ {d}_{k} ( 1 + {γ}_{1} ) + n - {d}_{k} ] \\ = 1 + ( 1 - \frac{{d}_{k}}{n} ) {γ}_{2}\end{matrix} \qquad ( 8 )$$

The parameters and γ₁ and γ₂ have many choices. For example, the choice γ₁=log 3/2 and γ₂=log 1/2 empirically works pretty well in our experiments.

The invention defines the symmetric dual of the pairwise PDF, namely Negative Document Frequency (NDF), to be the following form:

$${NDF}_{ij} ( {w}_{k} ) = \{ \begin{matrix}2 + {γ}_{1} + y & if {w}_{k} in 2 docs \\ y & if {w}_{k} in 1 docs \\ 2 + {γ}_{2} - y & if {w}_{k} in 0 docs\end{matrix} \qquad ( 9 )$$

where the parameter y is a non-negative real number, and the two documents are the i-th and j-th in the collection. Similar to IDF, it is a pairwise local metric to quantify the feature wₖ's capability of distinguishing the documents.

Finally, let x, y and z denote the first, second and last values respectively for each token count cases. Then PDF and its dual NDF have the following two relation equations below which describes their dynamics.

2+γ₁=x+y (10)

2+γ₂=y+z

Similar to PDF, by iterating one document through the corpus NDF also has two normalized expressions across the corpus. When the token feature wₖ appears in document Dᵢ, the normalized NDF has the following expression.

$$\begin{matrix}nND {F}_{i} ( {w}_{k} ) = \frac{1}{n} [ {d}_{k} ( 2 + {γ}_{1} - y ) + ( n - {d}_{k} ) y ] \\ = \frac{{d}_{k}}{n} ( 2 + {γ}_{1} ) + ( 1 - \frac{2 {d}_{k}}{n} ) y\end{matrix} \qquad ( 11 )$$

When the token feature wₖ does not appear in document Dᵢ, the normalized NDF has the following expression.

$$\begin{matrix}nND {F}_{i} ( {w}_{k} ) = \frac{1}{n} [ {d}_{k} y + ( n - d ) ( 2 + {γ}_{2} - y ) ] \\ = ( 1 - \frac{{d}_{k}}{n} ) ( 2 + {γ}_{2} ) - ( 1 - \frac{2 {d}_{k}}{n} ) y\end{matrix} \qquad ( 12 )$$

The invention defines the pairwise Positive and Negative Document Frequency (PNDF) to be the sum of PDF and NDF. That is,

PNDFᵢⱼ(wₖ)=PDFᵢⱼ(wₖ)+NDFᵢⱼ(wₖ) (13)

Similarly, the global normalized PNDF to be the sum of normalized PDF and NDF.

nPNDFᵢ(wₖ)=nPDFᵢ(wₖ)=nNDFᵢ(wₖ) (14)

In the PDF and NDF formulas above, there are plenty flexibility of selecting the parameters. The invention proposes a specific choice by applying the Strict Proper Score Algorithm to a pair of documents. The strict proper score algorithm is a scoring method which assigns the inverse of the logarithm of its probability to each of its exclusive conditions. Thus let's fix some notations first.

### Let

$${γ}_{1} = log ( \frac{n}{1 + d} ) , {γ}_{2} = log ( \frac{n}{1 + n - d} ) , \qquad ( 15 )$$

then we define the pairwise PDF as follows:

$${PDF}_{ij} ( {w}_{k} ) = \{ \begin{matrix}2 {γ}_{1} & if {w}_{k} appears in 2 docs i \& j \\ log \frac{1}{2} + {γ}_{1} + {γ}_{2} & if {w}_{k} appears in only one doc \\ 2 {γ}_{2} & if {w}_{k} appears in neither i or j\end{matrix} \qquad ( 16 )$$

### Correspondingly, the NDF as

$${NDF}_{ij} ( {w}_{k} ) = \{ \begin{matrix}2 {γ}_{1} - δ & if {w}_{k} appears in docs i \& j \\ log \frac{1}{2} + {γ}_{1} + {γ}_{2} + δ & if {w}_{k} appears in only one doc \\ 2 {γ}_{2} - δ & if {w}_{k} appears in neither i or j\end{matrix} \qquad ( 17 )$$

With the specific parameter values above, the corresponding normalized PDF and NDF weights have the following two different expressions according to the presence status of the feature wₖ. Let

$$entropy ( w ) = {γ}_{1} \frac{d}{n} + {γ}_{2} \frac{n - d}{n} .$$

The corresponding global forms can easily be derived as follows

$$\begin{matrix}Case w ∈ {D}_{i} \text{:} {nPDF}_{i}^{1} = entropy ( w ) + {γ}_{1} + ( 1 - \frac{{d}_{k}}{n} ) log ( \frac{1}{2} ) \\ {nNDF}_{i}^{1} = {PDF}_{i}^{1} + ( 1 - \frac{2 {d}_{k}}{n} ) δ & ( 18 ) \\ Case w ∉ {D}_{i} \text{:} {nPDF}_{i}^{0} = entropy ( w ) + {γ}_{2} + \frac{{d}_{k}}{n} log ( \frac{1}{2} ) \\ {nNDF}_{i}^{0} = {PDF}_{i}^{0} - ( 1 - \frac{2 {d}_{k}}{n} ) δ & ( 19 )\end{matrix}$$

The two dual schemes also have the following relation:

PDFᵢ¹+PDFᵢ⁰=NDFᵢ¹+NDFᵢ⁰. (20)

Note the weights above have two forms depending upon if a feature is present or absent in a document. This phenomena is caused by the introduction of dual document frequencies here. So the absence of a feature also contains useful information. In order to get such absence information, one needs redefine the feature to be the binary indicator of the absence of a token w. The corresponding term frequency document frequency representation vector is regarded as an additional component for the document distance computation.

The invention proposes a novel Binary Term Frequency (BTF) of a token feature wₖ in a document Dᵢ to be the following

$${BTF}_{i} ( {w}_{k} ) = \{ \begin{matrix}1 & if the feature count d \geq 0 in doc {D}_{i} \\ 0 & if the feature count d = 0 in doc {D}_{i}\end{matrix} \qquad ( 21 )$$

where the parameter d is the wₖ feature count in document Dᵢ. This simplified term frequency essentially indicates the presence status of features in a document, by ignoring the term frequency magnitude.

Following the well-known TF-IDF spirit, the invention further proposes the Binary Term Frequency Inverse Document Frequency (BTF-IDF) as the multiplication of BTF with IDF. That is, for token feature wₖ in document Dᵢ, we have the following formula:

BTF-IDFᵢ(wₖ)=BTFᵢ(wₖ)·IDF(wₖ) (22)

Thus documents can be represented as a vector of such coordinates.

Dᵢ=[BTF-IDFᵢ(w₁), . . . , BTF-IDFᵢ(wₘ)] (23)

For two documents Dᵢ and Dⱼ, the Euclidean distance between such vectors is denoted as Dist_{bt f idf}(Dᵢ, Dⱼ)

$$D i s {t}_{btfidf} ( {D}_{i} , {D}_{j} ) = \sqrt{{\sum }_{k = 1}^{m} {( B T F \text{-} {IDF}_{i} ( {w}_{k} ) - B T F \text{-} {IDF}_{j} ( {w}_{k} ) )}^{2}} \qquad ( 24 )$$

Similarly, the invention further proposes the Binary Term Frequency Positive Document Frequency (BTF-PDF) as the multiplication of BTF with the normalized PDF. That is, for token feature wₖ in document Dᵢ we have the following formula:

BTF-PDFᵢ(wₖ)=BTFᵢ(wₖ)·PDF(wₖ) (25)

Thus documents can be represented as a vector of such coordinates.

Dᵢ=[BTF-PDFᵢ(wᵢ), . . . , BTF-PDFᵢ(wₘ)] (26)

For two documents Dᵢ and Dⱼ, the Euclidean distance between such vectors is denoted as Dist_{bt f pdf}(Dᵢ, Dⱼ).

$${Dist}_{btfpdf} ( {D}_{i} , {D}_{j} ) = \sqrt{{\sum }_{k = 1}^{m} {( B T F \text{-} {PDF}_{i} ( {w}_{k} ) - B T F \text{-} {PDF}_{j} ( {w}_{k} ) )}^{2}} \qquad ( 27 )$$

Similarly, the invention further proposes the Binary Term Frequency Positive Document Frequency (BTF-NDF) as the multiplication of BTF with the normalized NDF. That is, for token feature wₖ in document Dᵢ, we have the following formula:

BTF-NDFᵢ(wₖ)=BTFᵢ(wₖ)·NDF(wₖ) (28)

Thus documents can be represented as a vector of such coordinates.

Dᵢ=[BTF-NDFᵢ(w₁), . . . , BTF-NDFᵢ(wₘ)] (29)

For two documents Dᵢ and Dⱼ, the Euclidean distance between such vectors is denoted as Dist_{bt f ndf}(Dᵢ, Dⱼ).

$${Dist}_{btfpdf} ( {D}_{i} , {D}_{j} ) = \sqrt{{\sum }_{k = 1}^{m} {( B T F \text{-} {NDF}_{i} ( {w}_{k} ) - B T F \text{-} {NDF}_{j} ( {w}_{k} ) )}^{2}} \qquad ( 30 )$$

Similarly, the invention further proposes the Binary Term Frequency Positive Negative Document Frequency (BTF-PNDF) as the multiplication of BTF with the normalized PNDF. That is, for token feature wₖ in document Dᵢ we have the following formula:

BTF-PNDFᵢ(wₖ)=BTFᵢ(wₖ)·PNDF(wₖ) (31)

Thus documents can be represented as a vector of such coordinates.

Dᵢ=[BTF-PNDFᵢ(wᵢ), . . . , BTF-PNDFᵢ(wₘ)] (32)

For two documents Dᵢ and Dⱼ, the Euclidean distance between such vectors is denoted as Dist_{bt f idf}(Dᵢ, Dⱼ).

$${Dist}_{btfpdf} ( {D}_{i} , {D}_{j} ) = \sqrt{{\sum }_{k = 1}^{m} {( B T F \text{-} {PNDF}_{i} ( {w}_{k} ) - B T F \text{-} {PNDF}_{j} ( {w}_{k} ) )}^{2}} \qquad ( 33 )$$

To leverage the above document distances emphasizing the presence status of features, the invention proposes including the BTF with suitable consistent document frequency based Euclidean distance components in the document distance computation when using various weighting schemes discussed above.

The invention further generalize the pairwise PDF, NDF, PNDF and their normalized variants to sentences or short phrases by summing the individual weights in the corresponding sentences or phrases. We denote the weighting scheme as Sentence Positive Document Frequency (SPDF). Let s=w₁w₂ . . . wₖ, where wᵢ's are nonstop words, then

$$S P D F ( s ) = {\sum }_{i = 1}^{k} P D F ( {w}_{i} ) \qquad ( 34 )$$

where the PDF can be the pairwise PDF or its normalized variants depending on the application context.

Similarly, the invention extends the definition for pairwise NDF or its normalized variant for sentences or short phrases, and denoted the sentence level NDF as SNDF.

$$S N D F ( s ) = {\sum }_{i = 1}^{k} N D F ( {w}_{i} ) \qquad ( 35 )$$

Similarly, the invention proposes the Positive Negative Document Frequency (PNDF) to be the natural summation of PDF and NDF. For sentences or short phrases, the generalized SPNDF is defined to be the accumulated sum of PNDF over tokens in the corresponding sentence or phrase, which is also equivalent to the sum of SPDF and SNDF.

$$S P N D F ( s ) = {\sum }_{i = 1}^{k} P N D F ( {w}_{i} ) = S P D F ( s ) + S N D F ( s ) \qquad ( 36 )$$

Both the above pairwise weighting schemes and their normalized variants can be straightforwardly applied to any pairwise document distance computing scenarios. These OT based document distance needs to solve an optimization problem at the cost of O(n³ log(n)) complexity. For the classical Euclidean distance computation, all the normalized weighting schemes introduced above can be applied straightforwardly to the features. Each document only needs once coordinates multiplication with weight schemes, while using pairwise weights requires different multiplication for each different pair of documents. These classical Euclidean distance computations has linear complexity only. Detailed demonstration in the two scenarios of optimal transportation based word token or sentence moving distance and Euclidean distance for text documents is given below.

The corpus collection of documents here is very generic. For example, a document could be a webpage, a news article, a facebook message etc. A feature could be a word, a generic token or symbol, or something slightly complex such as a sentence or a short phrase etc.

As an illustration, we show how the weighting schemes can be applied to the classical Euclidean distance computation and the optimal transportation based document distance computation. We use the same notation as in the background section above. At the word token level, the normalized word frequency vectors Dᵢ=[fᵢ₁, fᵢ₂, . . . , fᵢₘ] and Dⱼ=[fⱼ₁, fⱼ₂, . . . , fⱼₘ] represent document Dᵢ, and document Dⱼ. At the sentence level we get the similar representations Dᵢ=[s fᵢ₁, s fᵢ₂, . . . , s f_{iM}] and Dⱼ=[s fⱼ₁, s fⱼ₂, s f_{jM}], where M is the total different sentences or phrases in the two documents and s fᵢₖ denotes the normalized frequency count of k-th sentence in document Dᵢ.

For the classical Euclidean distance computation for a pair of documents, we use PDFᵢⱼ(w) denote the pairwise PDF of word token w for document Dᵢ and document Dⱼ. Multiplying each frequency with the corresponding PDF or its variant gives Dᵢ=[fᵢ₁PDFᵢⱼ(w₁)], . . . fᵢₘPDFᵢⱼ(wₘ)] and Yⱼ=[fⱼ₁PDFᵢⱼ(w₁), . . . , fⱼₘPDFᵢⱼ(wₘ)].

Recall the normalized weight schemes PDF and NDF have two forms for the presence or absence of a feature in a document. The default presence form contains most information while the absence form also contains some useful information. In the Euclidean distance computation below, a document can have both components and the distance between a pair of documents is the sum of the two corresponding component distances.

For the classical Euclidean distance computation with normalized weight schemes, then the normalized weight for features present in a document gives a document representation as Dᵢ=[fᵢ₁PDF(w₁)], . . . fᵢₘPDF(wₘ)], where the PDF(wₖ) is the default value when the feature is present in a document. This document representation can be used for the distance computation with other document in the corpus, without the need for further coordinates weight-update. So this global weight has advantages on computation cost. In the same spirit, the invention proposes the normalized weights of PDF, NDF and PNDF for the representation. Thus NDF gives

Dᵢ=[fᵢ₁NDF(w₁)], . . . , fᵢₘNDF(wₘ)], and PNDF gives

Dᵢ=[fᵢ₁PNDF(w₁)], . . . , fᵢₘPNDF(wₘ)].

Note the normalized weights also have a value when a feature is absent in a document. In order to use such information, the invention proposes first computing the negative term frequencies, denoted as n f, by counting if each feature is present in a document. That is, if a feature is present in a document, n f(wₖ)=0, otherwise n f(wₖ)=1. Thus the normalized weight for the absence of features gives each document representation as Dᵢ=[n fᵢ₁PDF (w₁)], . . . , n fᵢₘPDF(wₘ)],where the PDF(wₖ) here is the default value when the feature is absence in a document. Similarly NDF gives Dᵢ=[n fᵢ₁NDF(w₁)], . . . , n fᵢₘPNDF(wₘ)], and PNDF gives Dᵢ=[n fᵢ₁PNDF(w₁)], . . . , n fᵢₘPNDF(wₘ)].

The classical Euclidean distance between documents X=[x₁, . . . , xₘ] and Y=[y₁, . . . yₘ], denoted as Dist_{XY}, is then given as

$$D i s {t}_{XY} = \sqrt{{\sum }_{k = 1}^{n} {( {x}_{k} - {y}_{k} )}^{2}} \qquad ( 37 )$$

The equation gives all the distance for documents weighting using either IDF, PDF, NDF or PNDF.

For the Euclidean distance computation, the invention proposes the PNDF weight based distance with the usual term frequencies, also plus the PNDF weight based distance with the BTF.

Note the BTF-PNDF gives Dᵢ^{b}=[bt fᵢ₁PNDF(w₁)], . . . , bt fᵢₘ(wₘ)], while the TF-PNDF gives Dᵢ=[fᵢ₁PNDF(w₁)], . . . , fᵢₘPNDF(wₘ)].

$$\begin{matrix}{Dist}_{i j} = \sqrt{{dist ( {D}_{i}^{b} , {D}_{j}^{b} )}^{2} + {dist ( {D}_{i} , {D}_{j} )}^{2}} \\ = \sqrt{{\sum }_{k = 1}^{m} {PNDF}^{2} ( {w}_{k} ) [ {( {f}_{i k} - {f}_{{ }^{jk}} )}^{2} + {( b t {f}_{i k} - b t {f}_{jk} )}^{2} ]}\end{matrix} \qquad ( 38 )$$

For the Euclidean distance computation, the invention also proposes the easier IDF weight based distance with the usual term frequencies, also plus the IDF weight based distance with the BTF.

Note the BTF-IDF gives Dᵢ^{b}=[bt fᵢ₁IDF(w₁)], . . . , bt fᵢₘIDF(wₘ)], while the TF-IDF gives Dᵢ=[fᵢ₁IDF(w₁)], . . . , fᵢₘIDF(wₘ)].

$$\begin{matrix}{Dist}_{i j} = \sqrt{{dist ( {D}_{i}^{b} , {D}_{j}^{b} )}^{2} + {dist ( {D}_{i} , {D}_{j} )}^{2}} \\ = \sqrt{{\sum }_{k = 1}^{m} {IDF}^{2} ( {w}_{k} ) [ {( {f}_{i k} - {f}_{{ }^{jk}} )}^{2} + {( b t {f}_{i k} - b t {f}_{jk} )}^{2} ]}\end{matrix} \qquad ( 39 )$$

For the optimal transportation, the invention proposes applying the pairwise PNDF weighting to the normalized word frequency vectors X=[x₁, x₂, . . . , xₙ] and Y=[y₁, y₂, . . . , yₙ]. Then we need to normalize the vectors one more time and then solve the corresponding OT distances optimization problem using standard linear program solver or numeral approximation. For example, using PNDF weighting schemes gives Xᵢ=xᵢPNDF_{XY}(wᵢ) and Yⱼ=yⱼPNDF_{XY}(wⱼ). Here we need to re-normalize Xᵢ and Yⱼ, and make the vectors X and Y to have their coordinates sum equal to unity. Similarly, using PNDF weighting gives Xᵢ=xᵢPNDF_{XY}(wᵢ) and Yⱼ=yⱼPNDF_{XY}y(wⱼ), and do the same re-normalization.

The invention also proposes an integrated distance by including the pairwise PNDF based BTF Euclidean distance with the standard OT distance above. Note the BTF-PNDF gives Xᵢ=bt f xᵢPNDF _{XY}(wᵢ) and Yⱼ=bt f yⱼPNDF_{XY}(wⱼ), where bt f xᵢ and bt f yⱼ denote the binary version of the original feature xᵢ and yⱼ.

In the using PNDF weighting scheme such as above scenarios, the invention proposes tuning the parameter y in PNDF expression a bit for non-negative range for ideal performance in training of machine learning tasks such as document classification. For example, given the computed pairwise document distance, one can follow with a K Nearest Neighbor (KNN) algorithm for classification. First using the training data to find the optimal parameters such as y and then use them on the test dataset.

At the sentence level, using SNDF weighting gives Xᵢ=xᵢSNDF_{XY}(wᵢ) and Yⱼ=yⱼSNDF_{XY}(wⱼ). Similarly, using SPNDF or its variant weighting gives Xᵢ=xᵢSPNDF_{XY}(wᵢ) and Yⱼ=yⱼSPNDF_{XY}(wⱼ). We will also need do one more re-normalization before solving the corresponding optimization problem. The rest can be computed in the standard OT framework as above.

While the various embodiment of the present invention have been described above, it should be understood that they have been presented by way of example, and not limitation. As it is easy for a skilled person to make various changes in form and detail therein without departing from the spirit and scope of the invention. It is also to be understood that the following claims are intended to cover all of the generic and specific features of the invention herein described and all statements of the scope of the invention which, as a matter of language, might be said to fall there between.

What is claimed:

1. A novel pairwise document frequency weighting method, Negative Document Frequency(NDF) for a corpus of documents, comprising: choosing the intended feature set of documents;
performing a feature token or symbol counting for each pair of documents, with count value ends up in 0,1 or 2;
selecting parameters γ₁, γ₂ and y;
assigning a weighting value using the defining formula with selected parameter.

2. The method of claim 1, wherein its symmetric dual pairwise Positive Document Frequency (PDF) comprising:
two parameters γ₁ and γ₂;
three cases respectively for the feature count value 0, 1, and 2;
the values are described precisely in equation (6);
its relation to NDF is given in equations (10).

3. The method of claim 1, further comprising:
summing with its dual PDF above gives the integrated comprehensive pairwise Positive Negative Document Frequency (PNDF) document frequency.

4. The method of claim 3, further comprising:
computing the global normalized form PNDF across the corpus as the average of all pairwise PNDF by iterating the corpus;
multiplying the feature term frequencies with corresponding PNDFs to get the TF-PNDF document representation vectors;
computing the pairwise Euclidean distances among the documents.

5. The method of claim 4, wherein the feature is a slightly complex structure such as a sentence rather than the simple discrete token or symbol, further comprising:
computing the token weights first and sum them up as the assigned weight for the complex sentence feature.

6. The Strict Proper Score based Positive Document Frequency comprising:
three cases respectively for the feature count value 0, 1, and 2;
each case's value is given as the inverse of logarithm of each case's probability;
the expression has two parameters γ₁ and γ, which can be described by the document frequency and corpus size using equation (15);
computing the normalized forms by iterating the corpus and averaging all the values.

7. The method of claim 6, further comprising:
computing its dual NDF using equation (17); computing the normalized forms by iterating the corpus and averaging all the values;
further computing the sum of the normalized PDF and NDF.

8. The method of claim 7, further comprising:
applying the pairwise PNDF weighting to each of pair of documents for the Optimal transportation based word token or sentence moving distance for machine learning tasks such as classification and prediction etc; applying the normalized PNDF weighting to each document for the Euclidean document distance for machine learning tasks such as classification and prediction etc.

9. The Binary Term Frequency (BTF) based document frequency method comprising:
mapping the standard term frequencies of a document to the binary indicator of feature presence;
selecting a document frequency such as IDF or normalized PNDF to multiply with;
obtaining a BTF-PNDF type document representation vector;
obtaining a BTF-IDF type document representation vector.

10. The method of claim 9, further comprising:
computing the Euclidean distance between documents using their normalized BTF-PNDF based representation vectors;
computing the Euclidean distance between documents using their BTF-IDF based representation vectors.

11. The method of claim 9, further comprising:
selecting a pairwise document frequency PNDF and computing the pairwise BTF-PNDF representation vectors;
adding the computed BTF based Euclidean distance above to the optimal transportation distance computed in claim 8.

12. The method of claim 11, further comprising:
adding the TF-PNDF based Euclidean distance computed in claim 4 to obtain the integrated document distance.

13. A document distance computing system comprising:
a server, including a processor and a memory, to:
accepting inputs as a collection of document;
selecting a type of feature which can be a discrete token or symbol;
computing the feature frequency counts for each document and normalize it to a unit vector;
selecting a type of document frequency weighting such as PNDF and then computes the TF-PNDF document representation vectors;
computing document distance for each pair of documents in the corresponding framework, where it could be classical Euclidean document distance or the optimal transportation based word token moving distance.

14. The system of claim 13, wherein the server adds the suitable pairwise BTF-PNDF based Euclidean distance to the optimal transportation distance;
the server adds the suitable normalized BTF-PNDF or BTF-IDF based Euclidean distance to the classical Euclidean distance.

15. The system of claim 14, wherein the server' outputs may be followed by applying a standard procedure such as K Nearest Neighborhood (KNN), Support Vector Machine (SVM), Boosting Decision Trees or some Neural Network models etc for classification or prediction tasks etc.

16. The system of claim 14, wherein the server uses the slightly complex features such as sentences or short phrases rather than discrete tokens. For the sentence-like structure features, the server sums the corresponding individual document frequency weights of each token in the sentence-like features.

17. The system of claim 13, wherein the document distance uses the optimal transportation, the server uses the memory to store the word vectors for the vocabulary; and the server computes the pairwise word vector distance as the transportation cost of moving a word unit to another word unit in the word pair. The server then uses standard linear program solver for the optimal transportation plan estimation.
